(19) United States
(12) Patent Application Publication
(10) Pub. No.: US 2021/0067986 A1
(43) Pub. Date: Mar. 4, 2021

(54) WIRELESS ANALYSIS DEVICE AND WIRELESS ANALYSIS METHOD

(71) Applicant: Hitachi, Ltd., Tokyo (JP)

(72) Inventor: Ryota YAMASAKI, Tokyo (JP)

(73) Assignee: Hitachi, Ltd., Tokyo (JP)

(21) Appl. No.: 17/000,595

(22) Filed: Aug. 24, 2020

(30) Foreign Application Priority Data
Sep. 3, 2019 (JP) 2019-160470

(51) Int. Cl. H04W 24/08

(52) U.S. Cl. CPC H04W 24/08

(57) ABSTRACT

A wireless analysis device includes an antenna and a wireless reception unit configured to receive a wireless signal; a spectrogram calculation unit configured to acquire a spectrum waveform of the wireless signal; an identification unit configured to identify the wireless signal based on a pattern of the spectrum waveform; and an output unit configured to output an identification result obtained by the identification unit.

### CLAIM OF PRIORITY

The present application claims priority from Japanese patent application JP 2019-160470 filed on Sep. 3, 2019, the content of which is hereby incorporated by reference into this application.

### BACKGROUND OF THE INVENTION

### 1. Field of the Invention

The present invention relates to an analysis device of a wireless communication system.

### 2. Description of the Related Art

JP-A-2015-50622 (Patent Literature 1) describes a technique related to an analysis device of a wireless communication system.

Patent Literature 1 describes a channel use state acquisition device including a reception unit configured to receive a received signal, an acquisition unit configured to acquire a spectrogram related to the received signal received by the reception unit, a receiving unit configured to receive a frequency matrix that is a non-negative matrix corresponding to a frequency domain and has a basis vector corresponding to a frequency spectrum that corresponds to each frequency channel, a decomposition unit configured to decompose a spectrogram matrix, that is a non-negative matrix corresponding to the spectrogram acquired by the acquisition unit, into the frequency matrix and a time matrix that is a non-negative matrix corresponding to a time domain by non-negative matrix factorization, and a channel use state acquisition unit configured to acquire a use state of each frequency channel using the time matrix decomposed by the decomposition unit (see claim 1).

An Internet of Things (IoT) system based on wireless connection has been studied and introduced in various fields such as railways, construction machines, factories, warehouses, and the like. In these systems, since wireless communication quality is directly connected to a system operation rate, there is a demand for a wireless engineering technology for evaluating the quality of the wireless communication in a field and analyzing a behavior of a wireless system.

There are a plurality of wireless communication standards used in the IoT system, and the various wireless communication standards such as WiFi, zigbee (registered trademark), bluetooth (registered trademark), mobile phone (3G/4G), and LPWA are used. Further, a wireless system of an original standard different from these communication standards is also used, and there is a system using various wireless methods such as a remote control operation of a crane, remote monitoring of a hygrothermograph, and the like.

In the field where these various wireless communications are used, there is a demand for evaluating the quality of the wireless communication and analyzing the behavior of the wireless system without relying on the wireless method. In the technique described in Patent Literature 1, the wireless communication quality can be evaluated by acquiring a state of the frequency channel, but no consideration is given to analyzing the behavior of the wireless system.

### SUMMARY OF THE INVENTION

The present invention has been made in view of the above circumstances, and an object of the present invention is to evaluate quality of wireless communication and analyze a behavior of a wireless system without relying on a wireless communication method in a field where an IoT system operates under an environment where the wireless systems of various wireless communication standards are operated.

A representative example of the invention disclosed in the present application is as follows. That is, a wireless analysis device includes an antenna and a wireless reception unit configured to receive a wireless signal; a spectrogram calculation unit configured to acquire a spectrum waveform of the wireless signal; an identification unit configured to identify the wireless signal based on a pattern of the spectrum waveform; and an output unit configured to output an identification result obtained by the identification unit.

According to one aspect of the present invention, quality of wireless communication can be evaluated without relying on a wireless communication standard or a wireless communication method. Problems, configurations, and effects other than those described above will become apparent from the following description of embodiments.

### BRIEF DESCRIPTION OF THE DRAWINGS

FIG. 1 is a diagram showing a schematic configuration of a wireless communication system and a wireless analysis device of a first embodiment.

FIG. 2 is a functional block diagram of the wireless analysis device of the first embodiment.

FIG. 3 is a diagram showing a process of classifying a shape of spectrum power for each pattern and identifying the shape.

FIG. 4 is a diagram showing examples of the shape pattern of the spectrum power.

FIG. 5 is a diagram showing an example of a communication analysis table.

FIG. 6 is a diagram showing a process performed by an analysis unit.

FIG. 7 is a spectrogram when the wireless communication system is in a normal communication state.

FIG. 8 is a spectrogram when the wireless communication system is in an abnormal communication state.

FIG. 9 is a diagram showing an example of information displayed by an output unit as results of an identification and analysis process.

FIG. 10 is a diagram showing another example of information displayed by the output unit as results of the identification and analysis process.

FIG. 11 is a diagram showing an example of a hardware configuration of a wireless analysis device according to a second embodiment.

FIG. 12 is a diagram showing an example of a hardware configuration of a wireless analysis device according to a third embodiment.

### DESCRIPTION OF THE PREFERRED EMBODIMENTS

In the following embodiments, description may be divided into a plurality of sections or embodiments if necessary for convenience. In the following embodiments, when a number and the like (including the number, a numeric value, an amount, a range, and the like) of an element is referred to, these parameters are not limited to the specific numbers, and the values may be equal to or greater than or equal to or less than these specific numbers, unless otherwise specified or unless the specific numbers are clearly limited to specific numbers in principle. It should be noted that in the following embodiments, it is needless to say that components (including process steps) are not necessarily indispensable unless otherwise stated or except a case where the components are clearly considered to be indispensable in principle.

Further, each configuration, function, processing unit, processing method, and the like in the following embodiments may be partially or entirely implemented as, for example, an integrated circuit or other hardware. Further, each configuration, function, processing unit, processing method, and the like to be described later may be implemented as a program executed on a computer. That is, they may be implemented as software. Information such as a program, a table, a file, and the like that implement each configuration, function, processing unit, processing method, and the like can be stored in a storage device such as a memory, a hard disk, and a solid state drive (SSD), or storage media such as an IC card, an SD card, and a DVD.

Hereinafter, embodiments of the present invention will be described in detail with reference to the drawings. In all the drawings for explaining the embodiments, members having the same function are denoted by the same or related reference numerals, and repetitive descriptions thereof are omitted. Further, in the following embodiments, description of the same or similar portion will not be repeated in principle unless particularly necessary.

### First Embodiment

### System Configuration

The first embodiment includes a wireless analysis device (WA) 200 for analyzing a wireless communication system including access points (AP) that are a plurality of wireless base stations and mobile stations (STA) that are a plurality of mobile wireless stations. Hereinafter, the wireless communication system and the wireless analysis device 200 according to the first embodiment of the present invention will be described with reference to the drawings.

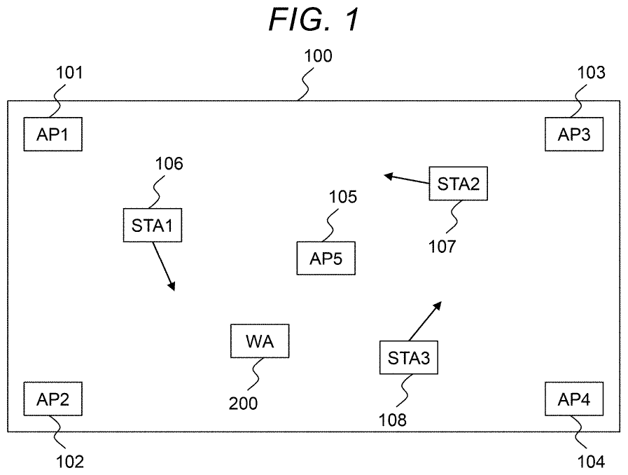

First, a schematic configuration of the wireless communication system and the wireless analysis device 200 according to the first embodiment will be described with reference to FIG. 1. FIG. 1 is a diagram showing the schematic configuration of the wireless communication system and the wireless analysis device 200 according to the first embodiment. The wireless communication system shown in FIG. 1 is provided in an indoor environment 100 in a building such as a factory or a warehouse. However, the present invention is not limited to being applied to the indoor environment, and can be applied to an outdoor environment. The wireless communication system includes the access points (APs) 101, 102, 103, 104, and 105 that are the plurality of wireless base stations and the mobile stations (STAs) 106, 107, and 108 that are the plurality of mobile wireless stations. Each AP is disposed as shown in FIG. 1 in the indoor environment. Each STA can move freely inside the indoor environment 100. Each AP and each STA are connected to each other by wireless communication. Each STA is assumed to be a general wireless communication system that performs a roaming operation for switching the AP of a connection destination in accordance with the movement. The wireless analysis device (WA) 200 for analyzing this wireless communication system is provided at a fixed position in the indoor environment 100, and the wireless analysis device (WA) 200 does not move.

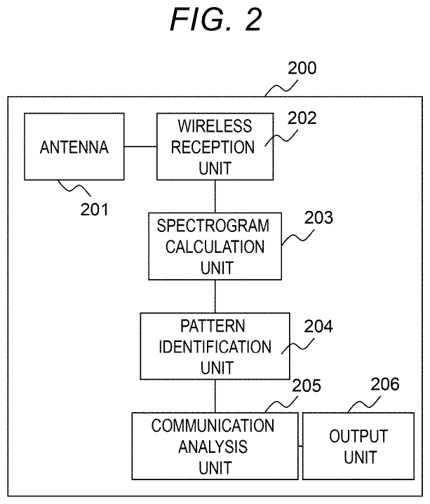

Next, functional blocks of the wireless analysis device (WA) 200 will be described with reference to FIG. 2. FIG. 2 is a functional block diagram of the wireless analysis device 200. As shown in FIG. 2, the wireless analysis device 200 includes an antenna 201, a wireless reception unit 202, a spectrogram calculation unit 203, a pattern identification unit 204, a communication analysis unit 205, and an output unit 206.

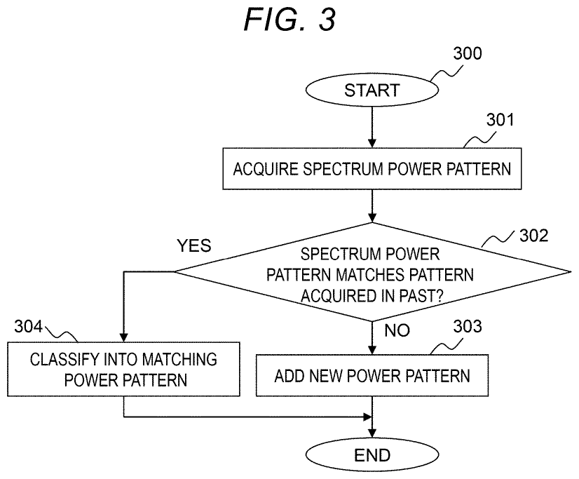

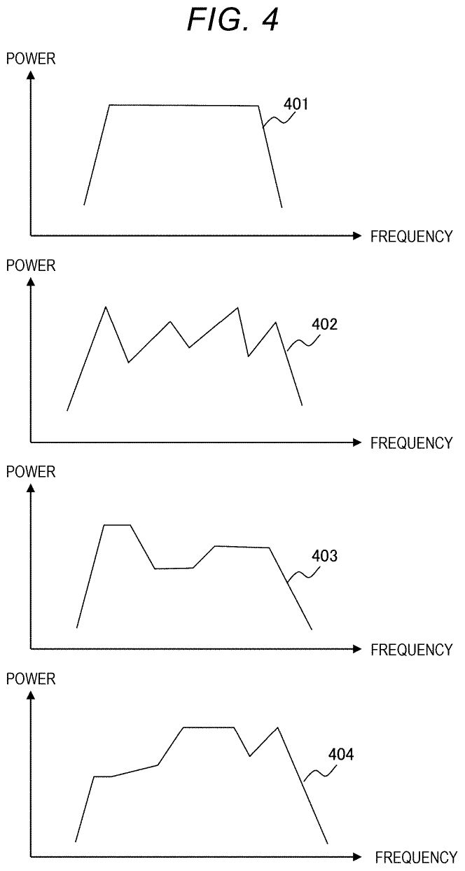

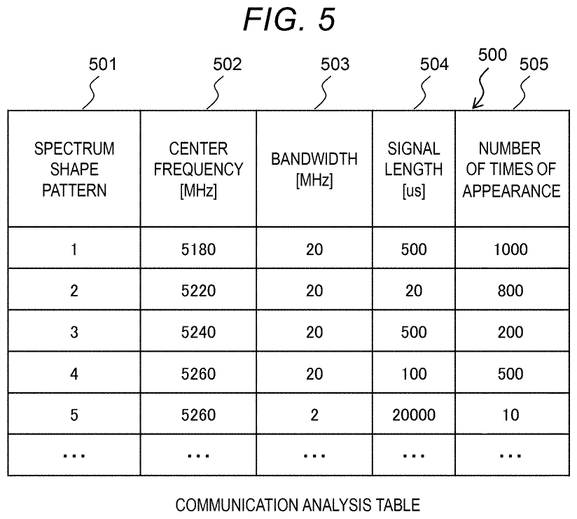

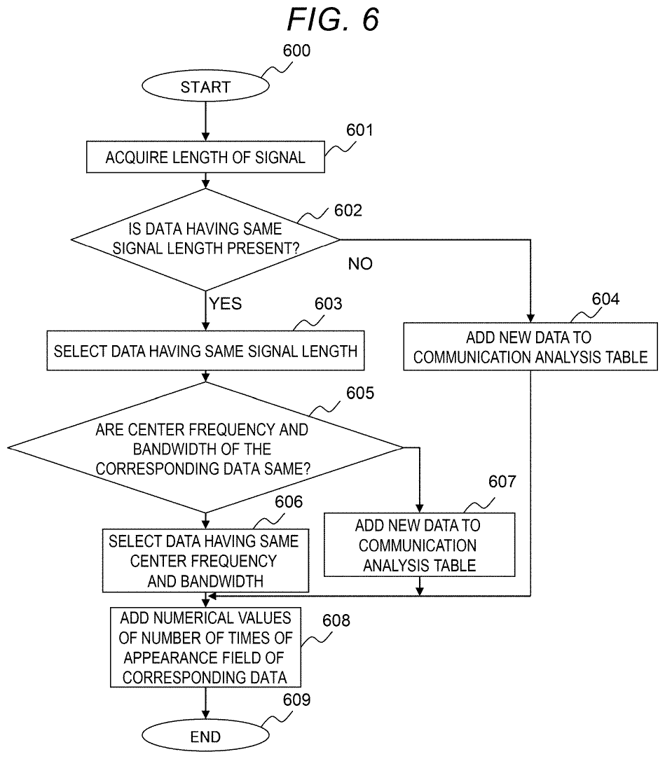

The antenna 201 has a function of receiving an electric wave. The wireless reception unit 202 down-converts the received electric wave and performs AD conversion to convert the electric wave into a digital signal. The spectrogram calculation unit 203 calculates a spectrogram (data format representing time variation of a frequency spectrum) of the digitized wireless signal. The pattern identification unit 204 identifies spectrogram data according to the distortion of a power spectrum of the signal, and detailed operations will be described with reference to FIGS. 3 and 4. The communication analysis unit 205 analyzes a communication amount in each signal pattern identified by the pattern identification unit 204, and detailed operations will be described with reference to FIGS. 5 and 6. The output unit 206 outputs an analysis result obtained by the communication analysis unit 205 to a display device such as a monitor, and provides an operator of the wireless analysis device (WA) 200 with information.

Next, a process performed by the pattern identification unit 204 shown in FIG. 2 will be described with reference to FIGS. 3, 4, and 5. FIG. 3 is a diagram showing a process of classifying a shape of spectrum power for each pattern and identifying the shape, FIG. 4 is a diagram showing examples of the shape pattern of the spectrum power, and FIG. 5 is a diagram showing an example of a communication analysis table 500 for recording and storing the shape pattern of the spectrum power.

As shown in FIG. 3, the pattern identification unit 204 acquires a spectrum power pattern calculated by the spectrogram calculation unit 203 (301). FIG. 4 shows examples of the spectrum power pattern. A pattern 401 in FIG. 4 represents the spectrum power with the power on a vertical axis and the frequency on a horizontal axis, and illustrates a spectrum shape of an OFDM signal. It is known that a wideband signal such as the OFDM propagates through a space and is affected by frequency selective fading via a multipath propagation path due to reflection, diffraction, or the like, and as a result, distortion occurs in the spectrum shape. A pattern 402 of FIG. 4 illustrates a spectrum shape in which the distortion occurs due to the frequency selective fading. The distortion of the spectrum shape is affected by the multipath propagation path determined by a positional relationship between a transmitting station and a receiving station of the electric wave. Therefore, when the positional relationship between the transmitting station and the receiving station varies, as illustrated by patterns 403, 404 in FIG. 4, the spectrum shape is distorted into different shapes. A pattern obtained by identifying and classifying the different distortions is called a spectrum shape pattern.

In the first embodiment, a spectrum shape pattern of a signal transmitted by the AP1 (101) shown in FIG. 1 and received by the WA (200) will be described as 401, a spectrum shape pattern of a signal transmitted by the AP2 (102) and received by the WA (200) will be described as 402, a spectrum shape pattern of a signal transmitted by the AP3 (103) and received by the WA (200) will be described as 403, and a spectrum shape pattern received by the AP4 (104) will be described as 404. When each AP is provided at a fixed location, the wireless analysis device (WA) (200) is provided at a fixed location, and both do not move, the different spectrum shape patterns 401 to 404 are identified and the signals received by the WA (200) can be classified.

Next, the pattern identification unit 204 collates whether the spectrum power pattern acquired in 301 of FIG. 3 matches a spectrum shape pattern acquired in the past (302). The collation may be performed using the communication analysis table 500 shown in FIG. 5. The communication analysis table 500 is a table that stores and manages information of information fields 501 to 505 for one spectrum shape pattern, and includes a spectrum shape pattern 501, a center frequency 502, a bandwidth 503, a signal length 504, and the number of times of appearance 505 as the information fields. The pattern identification unit 204 searches for whether there is a similar spectrum shape pattern for the newly acquired spectral shape pattern with reference to the communication analysis table 500 (302). When there is no similar spectrum shape pattern, a new spectrum shape pattern is added to the communication analysis table 500 (303). Specifically, new information is added to the information field of the spectrum shape pattern 501 in the communication analysis table 500. When there is the similar spectrum shape pattern, the acquired spectrum power pattern is classified into the information field of the corresponding spectrum shape pattern 501 (304). In the first embodiment, the spectrum shape patterns 401 to 404 of FIG. 4 will be described as being stored as spectrum shape patterns 1 to 4 of FIG. 5.

Next, a process performed by the communication analysis unit 205 will be described with reference to FIG. 6. The communication analysis unit 205 acquires a length of time during which the spectrum shape pattern identified by the pattern identification unit 204 continues (601). It is determined whether the acquired length of time matches the signal length 504 field of the corresponding spectrum shape pattern in the communication analysis table 500 (602). When they match, the corresponding data having the same signal length is selected (603). When they do not match, data having anew signal length is added to the communication analysis table 500 (604). Next, it is determined whether a center frequency and a bandwidth of the spectrum shape pattern match values of the center frequency 502 field and the bandwidth 503 field in the selected data in the communication analysis table 500 (605). When they match, the corresponding data having the same center frequency and bandwidth is selected (606). When they do not match, new data is added to the communication analysis table 500 (607). Then, numerical values of the number of times of appearance 505 field of the selected data or the newly added data is added (608).

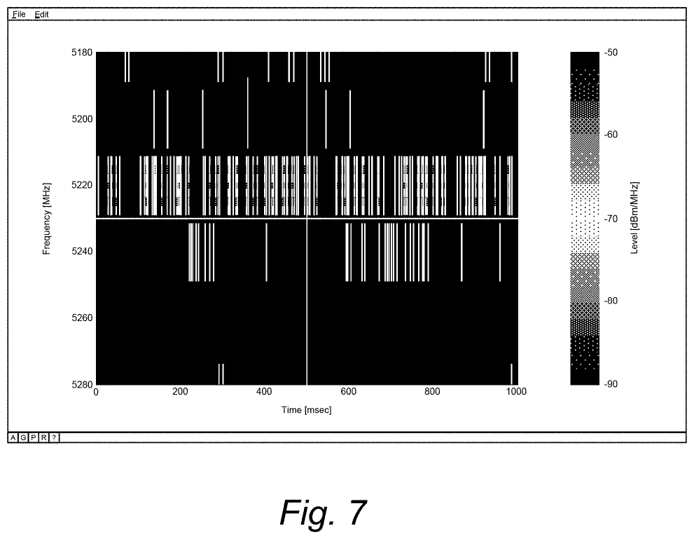

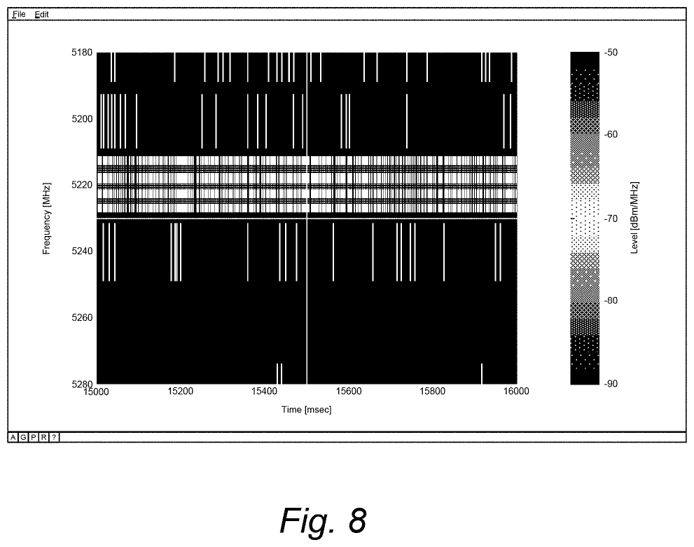

Next, an example of a process of identifying and analyzing an actual spectrum shape pattern will be described with reference to FIGS. 7 and 8. In FIGS. 7 and 8, description will be made using spectrogram information acquired by the wireless analysis device (WA) 200 in the configuration shown in FIG. 1. The vertical axis represents the frequency (MHz), the horizontal axis represents elapsed time (milliseconds), and shading represents a power intensity (dBm) of the signal. FIG. 7 is a spectrogram when the wireless communication system is in a normal communication state, and FIG. 8 is a spectrogram when the wireless communication system is in an abnormal communication state. It can be seen in FIG. 7 that the plurality of APs and STAs are transmitting and receiving wireless packets using a plurality of frequency channels. Similarly, the transmission and reception of wireless packets can be seen in FIG. 8, but FIG. 8 is different from FIG. 7 in that the packets are concentrated on a frequency channel having the center frequency of 5220 MHz and a striped pattern is visible in the spectrum. This striped pattern represents the distortion of the spectrum shape due to the frequency selective fading shown in FIG. 4. The striped pattern in the spectrum means that a specific AP monopolizes a wireless resource and continuously transmits the packets, and it can be determined that the wireless communication system is in the abnormal communication state as compared with FIG. 7. In this way, it is possible to identify the wireless station that is a transmission source of the signal based on the pattern of the distortion of the spectrum shape, and to analyze a degree to which each identified wireless station consumes the wireless resource (how much communication amount). The communication state of the wireless communication system can be analyzed by the configuration and the process shown in the first embodiment.

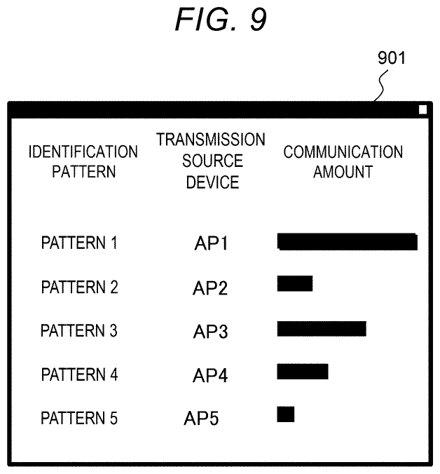

Next, an example of information displayed by the output unit 206 as results of an identification and analysis process will be described with reference to FIG. 9. An output example 901 displays the communication amount of each of the signals of the identified spectrum shape patterns. An identification pattern of the output example 901 corresponds to the spectrum shape pattern managed by the information analysis table 501, and a communication amount of the output example 901 corresponds to the number of times of appearance managed by 505 of the information analysis table. Further, the signals having the respective identification patterns are estimated to be the signals transmitted by the specific AP. As a result, the wireless communication amount of each AP and a consumption amount of the wireless resource can be analyzed in the wireless communication system shown in FIG. 1.

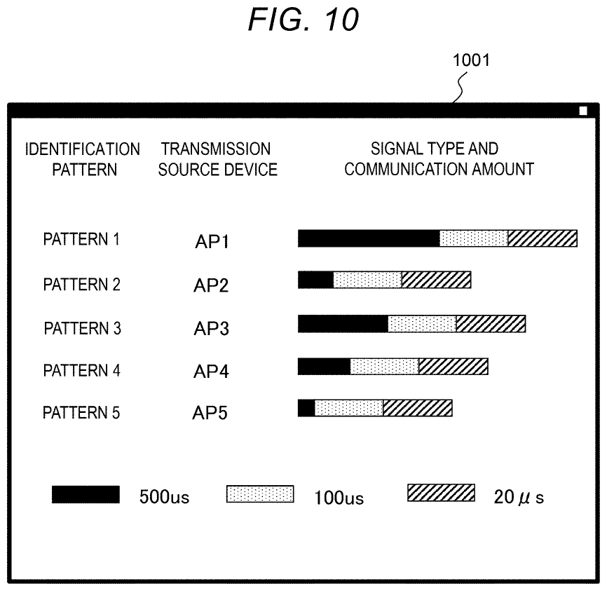

Next, another example of the information displayed by the output unit 206 as the results of the identification and analysis process will be described with reference to FIG. 10. An output example 1001 classifies the identified spectrum shape patterns according to lengths of the signal (for example, three types of 500 μs, 100 μs, and 20 μs), and displays the number of times of communication for each. In the output example 1001, a ratio of a signal having the length of 500 μs, a signal having the length of 100 μs, and a signal having the length of 20 μs can be found in a signal pattern 1 which is estimated to be transmitted by the AP1. Since the length of the signal changes depending on a type of signal and an amount of data to be transmitted, it is possible to analyze tendencies such as a speed of data communication and a type of packet to be transmitted and received (data packet or management packet).

The example in which the output unit 206 outputs screens shown in FIGS. 9 and 10 as the results of the identification and analysis process has been described. However, the output unit 206 may output some items (spectrum shape pattern 501, center frequency 502, and bandwidth 503) in the communication analysis table 500 (FIG. 5) in which the analysis result of the pattern identification unit 204 is recorded.

### Second Embodiment

A second embodiment shows another hardware configuration for implementing the functions shown in the first embodiment. The functional block diagram of FIG. 2 shown in the first embodiment may be implemented as the single wireless analysis device 200. A wireless analysis device 1110 of the second embodiment is implemented as a hardware configuration by a high frequency element such as an antenna, a high frequency circuit, an FPGA, a digital circuit, a CPU, a memory, and software that implements control.

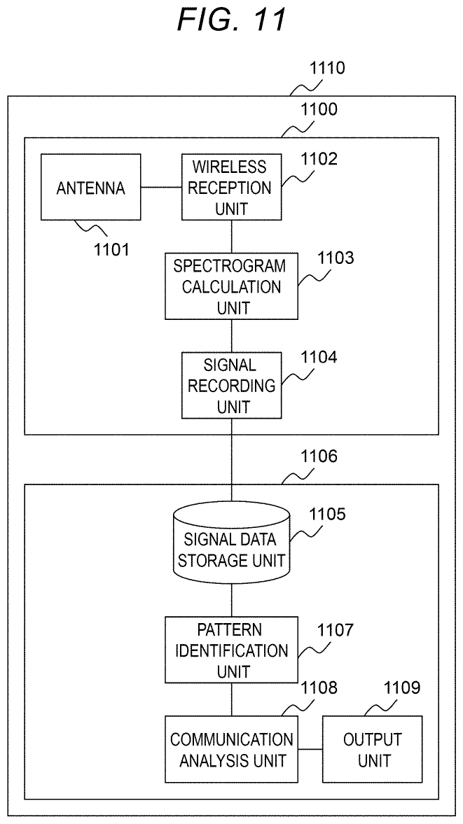

The hardware configuration of the wireless analysis device 1110 according to the second embodiment will be described with reference to FIG. 11. In the second embodiment, as shown in FIG. 11, the wireless analysis device 1110 is implemented by the hardware configuration divided into a wireless unit (for example, wireless measuring device) 1100 that receives the wireless signal, converts the wireless signal into the spectrogram data, and records the wireless signal as signal data, and a signal processing unit 1106 that identifies, analyzes, and outputs the signal. The wireless unit 1100 includes an antenna 1101, a wireless reception unit 1102, a spectrogram calculation unit 1103, and a signal recording unit 1104 that records a spectrogram-converted signal. The signal recording unit 1104 stores and maintains signal data (for example, spectrogram data) output to the signal processing unit 1106. The signal processing unit 1106 includes a signal data storage unit 1105, a pattern identification unit 1107, a communication analysis unit 1108, and an output unit 1109. The signal data storage unit 1105 stores the signal data (spectrogram data) output from the wireless unit 1100.

In comparison with the first embodiment, each configuration of the second embodiment includes the antenna 1101 the same as the antenna 201, the wireless reception unit 1102 the same as the wireless reception unit 202, the spectrogram calculation unit 1103 the same as the spectrogram calculation unit 203, the pattern identification unit 1107 the same as the pattern identification unit 204, the communication analysis unit 1108 the same as the communication analysis unit 205, and the output unit 1109 the same as the output unit 206, and therefore the descriptions thereof will be omitted.

As a practical configuration, for example, the wireless unit 1100 may be configured with the wireless measuring device such as a spectrum analyzer, and the signal processing unit 1106 may be configured with software process on a personal computer. The waveform data converted into the spectrogram is output by the wireless unit (spectrum analyzer) 1100 and input to the signal processing unit (personal computer) 1106. In this configuration, since the signal processing unit 1106 does not need to process the received signal in real time, the signal processing unit 1106 can analyze a signal having a large data amount in a wider band.

### Third Embodiment

A third embodiment shows another hardware configuration for implementing the functions shown in the first embodiment. The functional block diagram of FIG. 2 shown in the first embodiment may be implemented as the single wireless analysis device 200. A wireless analysis device 1210 of the third embodiment is implemented as a hardware configuration by a high frequency element such as an antenna, a high frequency circuit, an FPGA, a digital circuit, a CPU, a memory, and software that implements control.

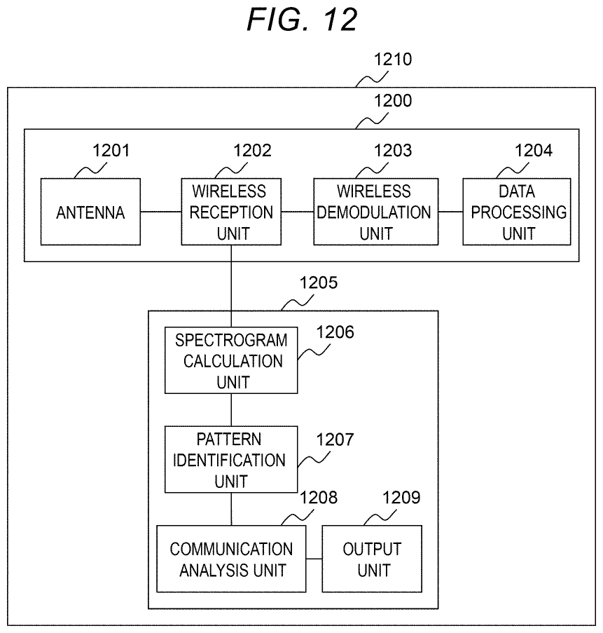

A hardware configuration of the wireless analysis device 1210 according to the third embodiment will be described with reference to FIG. 12. In the third embodiment, as shown in FIG. 12, a wireless communication unit 1200 that implements a normal wireless communication function and an analysis processing unit 1205 that performs signal analysis process are configured in one wireless communication device. The wireless communication unit 1200 and the analysis processing unit 1205 may be configured with different hardware. The wireless communication unit 1200 includes an antenna 1201, a wireless reception unit 1202, a wireless demodulation unit 1203, and a data processing unit 1204. The wireless reception unit 1202 down-converts a received electric wave to perform AD conversion, converts the electric wave into a digital signal, and outputs the digital signal into the wireless demodulation unit 1203 and the analysis processing unit 1205. The wireless demodulation unit 1203 demodulates a wireless (high frequency) signal and extracts a data signal. The data processing unit 1204 processes the demodulated digital data. Further, the analysis processing unit 1205 includes a spectrogram calculation unit 1206, a pattern identification unit 1207, a communication analysis unit 1208, and an output unit 1209. The same process as the process shown in the first embodiment can be implemented by inputting the wireless signal received by the wireless reception unit 1202 to the analysis processing unit 1205.

In comparison with the first embodiment, each configuration of the third embodiment includes the antenna 1201 the same as the antenna 201, the wireless reception unit 1202 the same as the wireless reception unit 202, the spectrogram calculation unit 1206 the same as the spectrogram calculation unit 203, the pattern identification unit 1207 the same as the pattern identification unit 204, the communication analysis unit 1208 the same as the communication analysis unit 205, and the output unit 1209 the same as the output unit 206, and therefore the descriptions thereof will be omitted.

The configuration of the third embodiment is not a single device that only performs the wireless analysis, but is a configuration in which a software analysis function is added to the wireless communication device (for example, a smartphone or a tablet terminal). There is no need to prepare the wireless analysis device 1210 separately from the wireless communication device, and in the wireless communication system shown in FIG. 1, the number of system components can be reduced and the cost can be reduced by providing only the wireless communication device having the analysis function. Further, the wireless communication system can be constantly monitored and analyzed.

As described above, since the wireless analysis devices 200, 1110, and 1210 according to the embodiments of the present invention include the antenna 201 and the wireless reception unit 202 that receive the wireless signal, the spectrogram acquisition unit (spectrogram calculation unit 203) that acquires the spectrum waveform of the wireless signal, the pattern identification unit 204 that identifies the wireless signal based on the pattern of the spectrum waveform, and the output unit 206 that outputs the identification result by the pattern identification unit 204, the quality of wireless communication can be evaluated and the behavior of the wireless system can be analyzed without relying on the wireless communication standard or the wireless communication method. Further, in the wireless system used in the field, it is possible to analyze the consumption of the wireless resource of each wireless device provided in the field.

Further, the wireless analysis device includes the communication analysis unit 205 that classifies the wireless signals identified by the pattern identification unit 204 by the signal length and counts the number of times of appearance of the classified wireless signals. Since the output unit 206 outputs the analysis result obtained by the communication analysis unit 205, the communication amount for each packet type can be analyzed.

Further, the pattern identification unit 204 identifies the pattern of distortion of the spectrum waveform acquired by the spectrogram calculation unit 203, classifies the pattern as the same spectrum waveform pattern when the pattern matches the spectrum waveform acquired in the past, and classifies the pattern as a new spectrum waveform pattern when the pattern is different from the spectrum waveform acquired in the past. Therefore, the pattern identification unit 204 can identify a transmission source of the wireless signal without depending on the protocol.

Further, the spectrum waveform pattern is distorted under the influence of the frequency selective fading, and the pattern identification unit 204 recognizes the signal having different distortion as a different spectrum waveform pattern. Therefore, the access point that is the transmission source of the wireless signal can be easily determined.

Further, the communication analysis unit 205 manages the information of the spectrum waveform by the communication analysis information (communication analysis table 500) including the spectrum shape pattern, the center frequency, the bandwidth, the signal length, and the number of times of appearance. Therefore, the analyzed wireless signal can be reliably managed.

Further, the communication analysis unit 205 searches for whether a signal having the same length as the signal length of the wireless signal identified by the pattern identification unit 204 is present in the communication analysis table 500, adds new data to the communication analysis table 500 when no signal having the same length is present, determines whether the center frequency and the bandwidth of the corresponding data are the same when the signal having the same length is present. The communication analysis unit 205 selects the data when the center frequency and bandwidth are the same, adds the new data to the communication analysis table 500 when the center frequency and bandwidth are different, and adds the number of times of appearance of the selected or added data. Therefore, the data in the communication analysis table 500 can be automatically updated, and the communication trends can be accurately analyzed.

Further, since the output unit 206 outputs the number of times of appearance counted for each spectrum waveform pattern as the communication amount (901), the communication amount for each access point can be known, and a size of the communication amount and bias in the communication can be known, which can contribute to the analysis of the system.

Further, since the output unit 206 outputs the number of times of appearance counted for each spectrum waveform pattern and each signal length as the communication amount for each signal type (1001), it can be known what kind of packet is being transmitted and to what extent the packet is being transmitted.

The present invention is not limited to the embodiments described above, and includes various modifications and equivalent configurations within the scope of the appended claims. For example, the embodiments described above have been described in detail in order to make the present invention easy to understand, and the present invention is not necessarily limited to those which have all the described configurations. A part of a configuration of a certain embodiment may be replaced with a configuration of another embodiment. The configuration of another embodiment may be added to the configuration of the certain embodiment. Further, a part of the configuration of each embodiment may be added to, deleted from, or replaced with another configuration.

Further, parts or all of the configurations, functions, processing units, processing methods described above and the like may be implemented by the hardware, for example by designing with the integrated circuit, or may be implemented by the software by a processor interpreting and executing a program that implements each function.

Information such as a program, a table, a file, and the like that implements each function can be stored in a storage device such as a memory, a hard disk, and a solid state drive (SSD), or a recording medium such as an IC card, an SD card, and a DVD.

Control lines and information lines indicate what is considered necessary for explanation, and not all the control lines and information lines in the products are shown. In practice, it may be considered that almost all the configurations are connected with each other.

What is claimed is:

1. A wireless analysis device comprising:
an antenna and a wireless reception unit configured to receive a wireless signal;
a spectrogram calculation unit configured to acquire a spectrum waveform of the wireless signal;
an identification unit configured to identify the wireless signal based on a pattern of the spectrum waveform; and
an output unit configured to output an identification result obtained by the identification unit.

2. The wireless analysis device according to claim 1, wherein
the identification unit is configured to
identify a pattern of distortion of the spectrum waveform acquired by the spectrogram calculation unit,
when the pattern matches a spectrum waveform acquired in the past, classify the pattern as the same spectrum waveform pattern, and
when the pattern is different from the spectrum waveform acquired in the past, classify the pattern as a new spectrum waveform pattern.

3. The wireless analysis device according to claim 1, wherein
the spectrum waveform pattern is distorted under an influence of frequency selective fading, and
the identification unit is configured to recognize a signal having different distortion as a different spectrum waveform pattern.

4. The wireless analysis device according to claim 1, further comprising:
an analysis unit configured to classify the wireless signals identified by the identification unit by a signal length and count the number of times of appearance of the classified wireless signal, wherein
the output unit is configured to output an identification result obtained by the analysis unit.

5. The wireless analysis device according to claim 4, wherein
the analysis unit is configured to manage information of the spectrum waveform by communication analysis information including a spectrum shape pattern, a center frequency, a bandwidth, a signal length, and the number of times of appearance.

6. The wireless analysis device according to claim 5, wherein
the analysis unit is configured to
search for whether there is a signal having the same length as the signal length of the wireless signal identified by the identification unit in the communication analysis information,
when there is the signal having the same length and a center frequency and a bandwidth of the corresponding data are the same, select the data,
when there is no signal having the same length and the center frequency and the bandwidth are different, add new data to the communication analysis information, and
add the number of times of appearance of the selected or added data.

7. The wireless analysis device according to claim 1, wherein
the output unit is configured to output the number of times of appearance counted for each pattern of the spectrum waveform as a communication amount.

8. The wireless analysis device according to claim 4, wherein
the output unit is configured to output the number of times of appearance counted for each pattern and each signal length of the spectrum waveform as a communication amount for each signal type.

9. The wireless analysis device according to claim 1, further comprising:
a wireless unit and a signal processing unit, wherein
the wireless unit includes the antenna, the wireless reception unit, the spectrogram calculation unit, and a signal recording unit configured to record waveform data converted into a spectrogram, and
the signal processing unit includes the identification unit and the output unit, and is configured to receive data of the spectrum waveform.

10. The wireless analysis device according to claim 1, further comprising:
a wireless communication unit and an analysis processing unit, wherein
the wireless communication unit includes the antenna, the wireless reception unit, a wireless demodulation unit, and a data processing unit, and
the analysis processing unit includes the spectrogram calculation unit, the identification unit, and the output unit, and is configured to receive a digital signal obtained by converting the received wireless signal.

11. A wireless analysis method performed by a wireless analysis device, comprising:
a wireless reception process of receiving a wireless signal;
a spectrogram acquisition process of acquiring a spectrum waveform of the wireless signal;
an identification process of identifying the wireless signal based on a pattern of the spectrum waveform; and
an output process of outputting a result of the identification.
